(19) United States
(12) Patent Application Publication
(10) Pub. No.: US 2015/0107077 A1
(43) Pub. Date: Apr. 23, 2015

(54) DETACHMENT DEVICE AND MATERIAL DETACHMENT PROCESS

(71) Applicant: John Hanson, Surrey (CA)

(72) Inventor: John Hanson, Surrey (CA)

(21) Appl. No.: 14/503,719

(22) Filed: Oct. 1, 2014

(30) Foreign Application Priority Data
Oct. 1, 2013 (CA) 2829255

(51) Int. Cl. B25B 27/14

(52) U.S. Cl. CPC B25B 27/14
USPC 29/426.5; 29/700

(57) ABSTRACT

A detachment device especially of use as a material detachment device for detaching installed drywall has a material-engagement portion and a handle portion. The material-engagement portion has a beveled free end. The handle portion has a handle free end, is engaged with the material-engagement portion, and is transverse to the material-engagement portion. The material-engagement portion and the handle portion are shaped and configured to wholly or partly detach either or both of installed material (such as drywall) and one or more attachment members (such as nails, screws, or dabs or beads of glue) by which the installed material is attached to one or more structural members (such as studs), through single or multiple application of either or both of (1) engagement of the beveled free end between (a) the installed material and (b) the one or more structural members to which the installed material is attached by the one or more attachment members; and (2) once the beveled free end is in engagement between the installed material and the one or more structural members to which the installed material is attached by the one or more attachment members, rotation of the handle portion transversely of the material-engagement portion. A material detachment process especially of use as a drywall detachment process includes two analogous steps preceded by accessing (a) the installed material and (b) the one or more structural members (such as studs) to which the installed material is attached by one or more attachment members.

### BACKGROUND OF THE PRESENT INVENTION

The present invention pertains to detachment devices and to material detachment processes. More particularly, the present invention pertains to a detachment device especially of use as a material detachment device for detaching installed drywall and to a material detachment process especially of use as a drywall detachment process.

Drywall detachment is commonly part of removal of installed drywall. More particularly, drywall is commonly installed horizontally or vertically by attaching 4′-wide drywall sheets to studs that are 1′ to 2′ from one another. Still more particularly, it is common that drywall is installed vertically in most commercial and residential applications and horizontally for walls in warehousing above 12 feet. In turn, removal of installed drywall commonly comprises detachment of installed drywall, followed by conveying the detached drywall to another location for reuse or disposal, and by cleanup of the dust and other debris from the detachment and from the conveying.

### SUMMARY OF THE PRIOR ART

Prior art is apparently only general background to the present invention.

For example, as compared to what is disclosed in Canadian Patents 2,323,740 and 1,063,092, the present invention more readily facilitates removal of installed drywall in larger pieces, and more cleanly and compactly, as well as potentially with less damage to studs, than has heretofore apparently been provided for.

### SUMMARY OF THE INVENTION

Disadvantages of prior art detachment devices and of prior art material detachment processes, and especially the disadvantages of commonly smaller detached drywall piece size and of commonly higher debris volume from the detachment and from the conveying as well as of damage to studs, may be overcome according to the present invention.

According to the present invention, there is provided a detachment device especially of use as a material detachment device for detaching installed drywall, comprising
material-engagement means comprising a beveled free end

and
handle means comprising a handle free end, and engaged with said material-engagement means and transverse to said material-engagement means,
   said material-engagement means and said handle means being shaped and configured to wholly or partly detach either or both of
installed material

and
one or more attachment members by which said installed material is attached to one or more structural members,
   through single or multiple application of either or both of
engagement of said beveled free end between
   said installed material
   and
   said one or more structural members to which said installed
   material is attached by said one or more attachment members

and
once said beveled free end is in engagement between said installed material and said one or more structural members to which said installed material is attached by said one or more attachment members, rotation of said handle means transversely of said material-engagement means.

Also according to the present invention, there is provided a material detachment process for detaching installed material from one or more structural members to which said installed material is attached by one or more attachment members and especially of use as a drywall detachment process, comprising single or multiple application of a set of steps to wholly or partly detach either or both of
said installed material

and
one or more of said one or more attachment members
   from said one or more structural members to which said installed material is attached by said one or more attachment members:
as a first step, accessing
   said installed material
   and
   said one or more structural members to which said installed material is attached by said one or more attachment members,
as a second step, engaging material-engagement means of a detachment device between
   said installed material
   and
   said one or more structural members to which said installed material is attached by said one or more attachment members,

and
as a third step, once said material-engagement means of a detachment device is in engagement between said installed material and said one or more structural members to which said installed material is attached by said one or more attachment members, rotating said detachment device transversely of said material-engagement means

### BRIEF DESCRIPTION OF THE DRAWINGS

In drawings which illustrate embodiments of the invention,

FIG. 1 is a profile view, of an embodiment of the detachment device according to the invention;

FIG. 2 is an isometric view, of the embodiment shown in FIG. 1;

FIG. 3A is a detail plan view of the beveled free end, of the embodiment shown in FIG. 1;

FIG. 3B is a detail profile view of the beveled free end, of the embodiment shown in FIG. 1; and

FIG. 4 is a plan view, of an embodiment of the material detachment process according to the invention.

### DETAILED DESCRIPTION OF THE PREFERRED EMBODIMENT

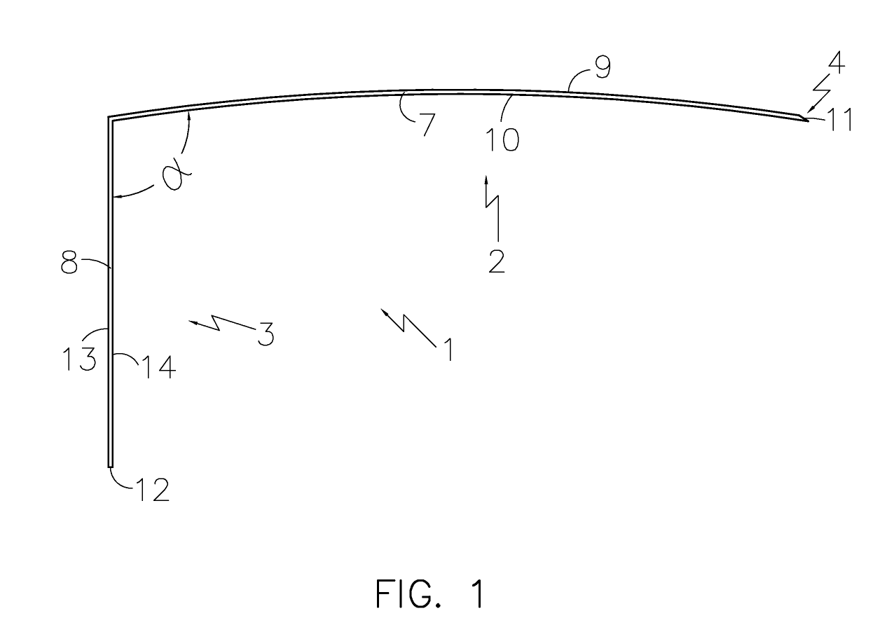

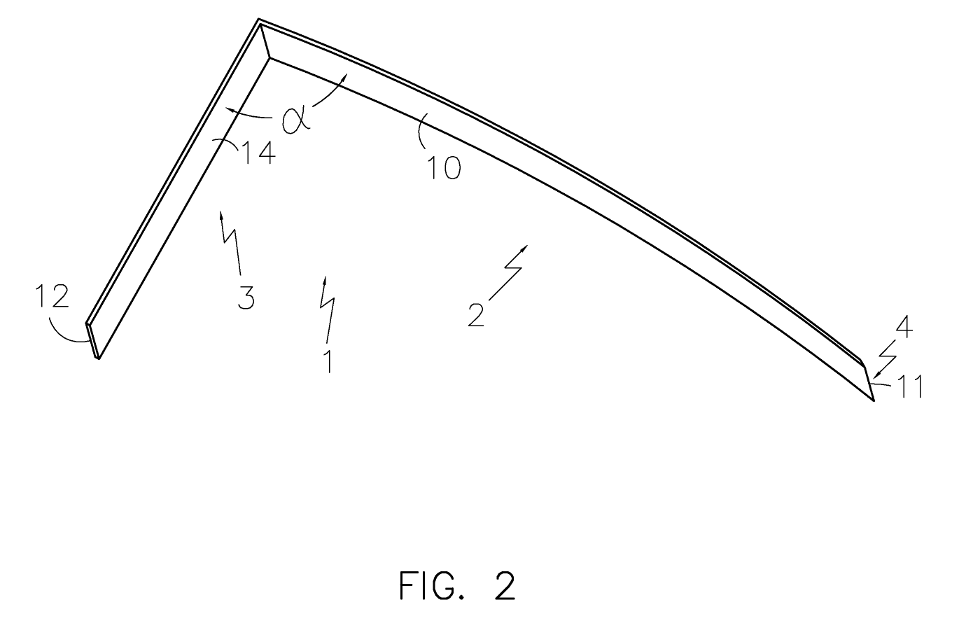

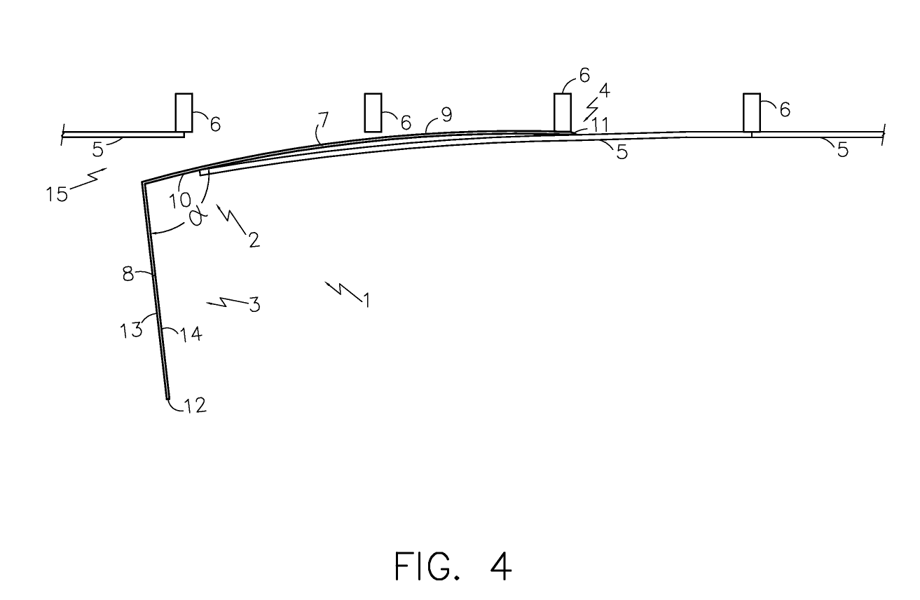

Referring especially to FIGS. 1, 2, 3A, and 3B, construction and use of the preferred embodiment of the detachment device according to the invention will be described; and referring especially to FIG. 4, the preferred embodiment of the material detachment process according to the invention will be described.

Referring to FIGS. 1, 2, and 4, detachment device 1 comprises material-engagement means 2 and handle means 3. Material-engagement means 2 comprises beveled free end 4 for engagement between installed material 5 (such as drywall shown in FIG. 4) and one or more structural members 6 (such as studs shown in FIG. 4) to which installed material 5 is attached by one or more attachment members such as nails, screws, or dabs or beads of glue (not shown). Handle means 3 is for generally positioning material-engagement means 2, for particularly positioning beveled free end 4 by engaging beveled free end 4 between installed material 5 and the one or more structural members 6, and, once beveled free end 4 is in engagement between installed material 5 and the one or more structural members 6, for then effecting rotation transversely of material-engagement means 2.

Referring to FIGS. 1, 2, 3A, and 3B, in the preferred embodiment of detachment device 1, material-engagement means 2 comprises material-engagement means 2 largely orthogonal to handle means 3. More particularly, material-engagement means 2 comprises material-engagement means 2 integral with and largely orthogonal to handle means 3. Still more particularly, material-engagement means 2 and handle means 3 comprise a device, and, even more particularly, a strip, of largely L-shaped profile respectively comprising a first arm 7 and a second arm 8, with an inner angle α between first arm 7 and second arm 8. First arm 7 comprises an outer face 9 and, adjacent inner angle α, an inner face 10; beveled free end 4 comprises beveling 11 of outer face 9 inwardly from outer face 9. Second arm 8 comprises handle free end 12, an outer face 13 and, adjacent inner angle α, an inner face 14.

Referring to FIGS. 1, 2, and 4, to facilitate beveled free end 4 being engaged between installed material 5 (such as drywall shown in FIG. 4) and one or more structural members 6 (such as studs shown in FIG. 4), and to facilitate rotation of handle means 3 transversely of material-engagement means 2, the preferred embodiment of detachment device 1 comprises further shaping, and further configuration, of material-engagement means 2 and handle means 3. More particularly, in the preferred embodiment of detachment device 1, first arm 7 has lengthwise deviation from the largely L-shaped profile, outwardly from inner angle α, such that displacement between beveled free end 4 and handle free end 12 is less, and inner angle α is equal to or greater, than if the lengthwise deviation were not present. That lengthwise deviation imparts a spring-like effect to detachment device 1, resulting in an aspect of the above-mentioned facilitation of engagement and of rotation.

As used in this disclosure and in the accompanying claims, the expression “displacement ratio” means the ratio of (a) displacement between beveled free end 4 and handle free end 12 when the lengthwise deviation is present to (b) displacement between beveled free end 4 and handle free end 12 when the lengthwise deviation is not present.

In the preferred embodiment of detachment device 1, each of inner angle α and displacement ratio can be selected from a range; the range of degrees of inner angle α is approximately 70 degrees to approximately 110 degrees and the range of displacement ratio is approximately 0.996 to approximately 0.998. The best inner angle α value is approximately 90 degrees and the best displacement ratio value is approximately 0.997.

Also more particularly, in the preferred embodiment of detachment device 1, the lengthwise deviation comprises rectilinear deviation, and, still more particularly, curvilinear deviation approximated by rectilinear deviation.

As well, in the preferred embodiment of detachment device 1, first arm 7 and second arm 8 are, in length ratio to one another, approximately 2:1 and, more particularly, first arm 7 and second arm 8 are respectively, in length, approximately 40″ long and approximately 20″ long. For those particular lengths, the strip is of an at least medium carbon steel (such as 1144 A311 CLB(CF)) squelched at its ends as well as between first arm 7 and second arm 8 and at each deviation, and is approximately 3/16″ thick and approximately 2″ wide. A detachment device 1 of that steel type, and having first arm 7 and second arm 8 of those respective lengths and of that thickness and that width, tends to especially be of use as a material detachment device for detaching ½″-thick installed drywall in 4′-wide sheets; that is especially so, because drywall is commonly installed horizontally or vertically by attaching 4′-wide drywall sheets to studs that are 1′ to 2′ from one another.

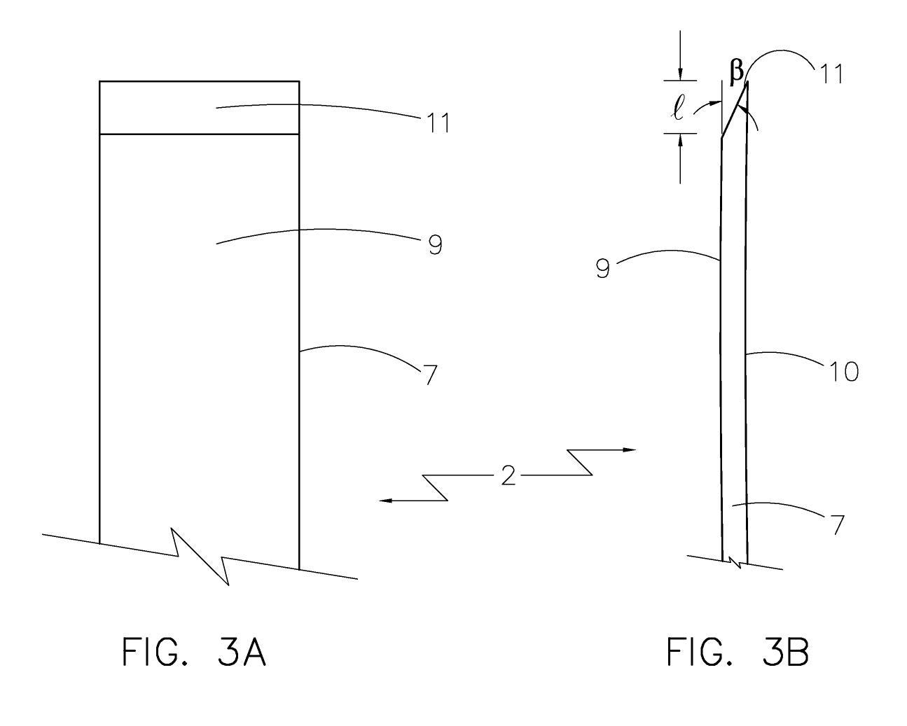

Referring to FIGS. 3A, 3B, and 4, beveling 11 comprises beveling at a constant angle as measured inwardly from outer face 9. More particularly, beveling 11 comprises beveling at a constant angle as measured inwardly from and lengthwise of outer face 9. Still more particularly, beveling 11 comprises beveling at constant angle β as measured inwardly from and lengthwise of outer face 9 and has constant length l as measured lengthwise of outer face 9. Each of constant angle β and constant length l can be selected from a range; the range of degrees of constant angle β is approximately 20 degrees to approximately 30 degrees and the range of lengths of constant length l is approximately 0.325″ to approximately 0.515″. The best constant angle β value is approximately 30 degrees and the best constant length l value is approximately 0.325″.

The preferred embodiment of detachment device 1 is constructed from 1144 A311 CLB(CF) planar steel sheet of a uniform thickness of approximately 3/16″, by first cutting from that sheet a strip approximately 2″ wide and approximately 60″ long; then, at one end of that strip, the edges of what will become second arm 8 are rounded by grinding as are the corners of what will become handle free end 12, for the safety of people making or handling the detachment device 1. Beveled free end 4 is then formed at the opposite end of that strip by grinding a face of that opposite end to produce beveled free end 4 depicted especially in FIGS. 3A and 3B. Then, that strip is bent to form first arm 7, second arm 8, inner angle α between first arm 7 and second arm 8, and the lengthwise deviation of each of first arm 7 and second arm 8 from what would otherwise be a largely L-shaped profile; that lengthwise deviation is outwardly from inner angle α, such that displacement between beveled free end 4 and handle free end 12 is less, and inner angle α is equal to or greater, than if the lengthwise deviation were not present. Lastly, to increase the hardness of portions of the device 1, the above-mentioned squelching should be done.

Referring to FIG. 4, the preferred embodiment of the material detachment process according to the invention is especially of use as a drywall detachment process. The material detachment process is for detaching installed material 5 (such as drywall shown in FIG. 4) from one or more structural members 6 (such as studs shown in FIG. 4) to which installed material 5 is attached by one or more attachment members such as nails, screws, or dabs or beads of glue (not shown).

Drywall removal commonly includes, as preparatory steps, removing casings from doorways and other openings, removing corner bead and L-edge, removing baseboards and ceiling trim, and, at room corners to which drywall tape and drywall mud were applied, cutting through that tape and that mud; it also commonly includes then removing any attachment members that appear as a result. Especially if installed material 5 is drywall overlapped by a floor or ceiling (such as by the floor or ceiling having been added after drywall installation) or installed tight to a floor or ceiling, then the material detachment process of the invention comprises a supplementary step before the second step; more particularly, that supplementary step is before the first step. The supplementary step comprises cutting into installed material 5 parallel to a horizontal edge of installed material 5, and more particularly, cutting into installed material 5 parallel to a horizontal edge of installed material 5 at approximately 2″ above the flooring or, as the case may be, at approximately 2″ below the ceiling, such that, in general that cut is at approximately 2″ from that horizontal edge, such that installed material 5 will fold back towards one or more structural members 6 as installed material 5 is detached.

The first step (of accessing installed material 5 and one or more structural members 6 to which installed material 5 is attached by one or more attachment members) comprises, in its first instance, making an opening 15, through installed material 5. That is done either of two ways. One way is such as by drilling and sawing, between structural members 6 to which installed material 5 is attached by one or more attachment members; the other way is such as by prying, on-seam between respective sheets of installed material 5 (having first removed or cut through whatever had been applied to that seam) either at the preferred location of an outside corner or otherwise. Opening 15 is shaped and configured to allow the second step and the third step. After the first instance of the first step, the third step provides the accessing prescribed by second and subsequent instances of the first step.

The second step (of engaging material-engagement means of a detachment device, such as beveled free end 4 of detachment device 1, between installed material 5 and one or more structural members 6 to which installed material 5 is attached by one or more attachment members) comprises, in its first instance, inserting material-engagement means of a detachment device, such as beveled free end 4 of detachment device 1, through opening 15 and engaging that material-engagement means between installed material 5 and one or more structural members 6 to which installed material 5 is attached by one or more attachment members. Second and subsequent instances of the second step do not have to include inserting material-engagement means of a detachment device, other than by the first instance of the second step; that is because the material-engagement means of the detachment device can remain behind installed material 5 and near one or more structural members 6 to which installed material 5 is attached by one or more attachment members, rather than, for example, the material-engagement means being withdrawn through opening 15 and then re-inserted through opening 15. If installed material 5 is 4′-wide drywall sheets installed horizontally, then engaging the material-engagement means of the detachment device used in the second step and in the third step (such as detachment device 1), is largely upward from horizontal or largely downward from horizontal, to detach installed material 5 in full sheets, or is largely horizontal, to detach installed material 5 in less than full sheets such as approximately 4′ sections.

The third step (of, once material-engagement means of a detachment device is in engagement between the installed material 5 and one or more structural members 6 to which the installed material 5 is attached by one or more attachment members, rotating the detachment device, such as the detachment device according to the invention, transversely of the material-engagement means) comprises, in its first and subsequent instances, the accessing prescribed by second and subsequent instances of the first step. Also, rotating the detachment device (such as the detachment device according to the invention) transversely of the material-engagement means of that detachment device comprises rotating that detachment device largely orthogonally of the material-engagement means. If the engaging done in the second step is largely horizontal, then the rotating done in the third step may be either largely upward from horizontal or largely downward from horizontal; if the engaging done in the second step is largely downward from horizontal, then the rotating done in the third step is largely upward from horizontal; and if the engaging done in the second step is largely upward from horizontal, then the rotating done in the third step is largely downward from horizontal.

Depending on the circumstances, one or more of the following three cautions may apply regarding either or both of the detachment device according to the invention and the material detachment process according to the invention: (1) if installed material 5 is other than ½″-thick drywall, such as, for example, ⅝″-thick drywall, then, in the material detachment process according to the invention, either or both of more force and more repetition may be needed; (2) because the present invention more readily facilitates removal of installed drywall in larger pieces than has heretofore apparently been provided for, those larger pieces might be more unwieldy than heretofore expected, so caution should be exercised accordingly, and, especially if the drywall sheets are installed vertically, bringing such larger pieces into contact with sprinkler heads should be guarded against; and (3) because the present invention more readily facilitates removal of installed drywall more compactly than has heretofore apparently been provided for, haulage load maximum weight limits might be reached at lesser load volumes than heretofore expected.

1-42. (canceled)

43. A detachment device for detaching installed material from a structural member, the device comprising:
a material-engagement part comprising a beveled free end; and
a handle part comprising a handle part free end, wherein the handle part is engaged with said material-engagement part at an end opposite said handle part free end;
wherein said material-engagement part and said handle part are shaped and configured to wholly or partially detach said installed material from said structural member.

44. The detachment device according to claim 43, wherein said material-engagement part is largely orthogonal to said handle part.

45. The detachment device according to claim 43, wherein said material-engagement part is integral with, and largely orthogonal to, said handle part.

46. The detachment device according to claim 43,
wherein said material-engagement part and said handle part comprise a strip of material of largely L-shaped profile comprising a first arm and a second arm, with an inner angle between said first arm and said second arm;
wherein said first arm comprises an outer face and, adjacent said inner angle, an inner face; and
wherein said beveled free end comprises beveling of said outer face inwardly from said outer face.

47. The detachment device according to claim 46, wherein said first arm has a lengthwise deviation from said largely L-shaped profile, outwardly from said inner angle, such that displacement between said beveled free end and said handle part free end is less, and said inner angle is equal to, or greater, than if said lengthwise deviation was not present.

48. The detachment device according to claim 46, wherein said inner angle is in a range between approximately 70 degrees and approximately 110 degrees.

49. The detachment device according to claim 43, wherein a ratio of displacement ratio between said beveled free end and said handle part free end is between approximately 0.996 and approximately 0.998.

50. The detachment device according to claim 46, wherein said inner angle is between approximately 70 degrees and approximately 110 degrees, and the ratio of displacement is between approximately 0.996 and approximately 0.998.

51. The detachment device according to claim 46, wherein said inner angle is approximately 90 degrees.

52. The detachment device according to claim 49, wherein the ratio of displacement is approximately 0.997.

53. The detachment device according to claim 49, wherein said inner angle is approximately 90 degrees, and the ratio of displacement is approximately 0.997.

54. The detachment device according to claim 47, wherein said lengthwise deviation comprises a rectilinear deviation.

55. The detachment device according to claim 47, wherein said lengthwise deviation comprises an approximately curvilinear deviation.

56. The detachment device according to claim 46, wherein said first arm and said second arm are, in length ratio to one another, approximately 2:1.

57. The detachment device according to claim 46, wherein said first arm and said second arm are, in length ratio to one another, approximately 2:1.

58. The detachment device according to claim 46, wherein said beveling of said outer face inwardly from said outer face comprises beveling at a constant angle as measured inwardly from said outer face.

59. The detachment device according to claim 58, wherein said beveling at a constant angle, as measured inwardly from said outer face, comprises beveling at a constant angle as measured inwardly from and lengthwise of said outer face.

60. The detachment device according to claim 59, wherein said beveling at a constant angle, as measured inwardly from and lengthwise of said outer face, comprises beveling of constant length, as measured lengthwise of said outer face.

61. The detachment device according to claim 59, wherein said constant angle, as measured inwardly from and lengthwise of said outer face, is in a range of approximately 20 degrees and approximately 30 degrees.

62. The detachment device according to claim 60, wherein said constant length, as measured lengthwise of said outer face, is in a range of approximately 0.325 inch and approximately 0.515 inch.

63. The detachment device according to claim 60, wherein said constant angle, as measured inwardly from and lengthwise of said outer face, is in a range of approximately 20 degrees and approximately 30 degrees, and said constant length, as measured lengthwise of said outer face, is in a range of approximately 0.515 inch and approximately 0.325 inch.

64. The detachment device according to claim 63, wherein said constant angle, as measured inwardly from and lengthwise of said outer face, is approximately 30 degrees.

65. The detachment device according to claim 60, wherein said constant length, as measured lengthwise of said outer face, is approximately 0.325 inch.

66. The detachment device according to claim 60, wherein said constant angle, as measured inwardly from and lengthwise of said outer face, is approximately 30 degrees, and said constant length, as measured lengthwise of said outer face, is approximately 0.325 inch.

67. A material detachment process using the detachment device according to claim 43 for wholly or partially detaching installed material from at least one of a structural member and an attachment member to which the installed material is attached, the method comprising:
accessing said installed material and said structural member to which said installed material is attached;
engaging the material-engagement part of the detachment device between said installed material and said structural member; and
rotating said detachment device transversely of said material-engagement part to wholly or partially detach the installed material from at least one of the structural member and attachment member.
